(19) United States
(12) Patent Application Publication
(10) Pub. No.: US 2012/0173846 A1
(43) Pub. Date: Jul. 5, 2012

(54) METHOD TO REDUCE THE ENERGY COST OF NETWORK-ON-CHIP SYSTEMS

(75) Inventors: Kai Feng Wang, Beijing (CN); Peng Fei Zhu, Beijing (CN); Hong Xia Sun, Beijing (CN); Yong Qiang Wu, Beijing (CN)

(73) Assignee: STMicroelectronics (Beijing) R&D Co., Ltd., Beijing (CN)

(21) Appl. No.: 13/325,614

(22) Filed: Dec. 14, 2011

(30) Foreign Application Priority Data
Dec. 30, 2010 (CN) 201010624754.6

(51) Int. Cl. G06F 15/76; G06F 9/22

(52) U.S. Cl. 712/32; 712/E09.004

(57) ABSTRACT

In a network-on-chip (NoC) system, multiple data messages may be transferred among modules of the system. Power consumption due to the transfer of the messages may affect a cost and overall performance of the system. A described technique provides a way to reduce a volume of data transferred in the NoC system by exploiting redundancy of data messages. Thus, if a data message to be sent from a source in the NoC includes so-called “zero” bytes that are bytes including only bits set to “0,” such zero bytes may not be transmitted in the NoC. Information on whether each byte of the data message is a zero byte may be recorded in a storage such as a data structure. This information, together with non-zero bytes of the data message, may form a compressed version of the data message. The information may then be used to uncompress the compressed data message at a destination.

### CROSS REFERENCE TO RELATED APPLICATIONS

This application claims the priority benefit of Chinese patent application number 201010624754.6, filed on Dec. 30, 2010, entitled A METHOD TO REDUCE POWER CONSUMPTION BY NETWORK-ON-CHIP SYSTEMS, which is hereby incorporated by reference to the maximum extent allowable by law.

### BACKGROUND OF THE INVENTION

1. Field of the Invention

As integrated circuits, or chips, become more advanced and versatile, technologies are developed which allow a single chip to accommodate multiple modules. The modules are often involved in complex interactions. In such system-on-chip technologies, a challenging task of providing reliable communication between the multiple modules integrated on a chip may be accomplished by utilizing a communication network. Such a network used to interconnect the modules on a chip is typically referred to as a network-on-chip (NoC). NoC may also provide communication between the modules on the chip and components or devices outside of the chip.

2. Discussion of the Related Art

NoC systems provide scalable and flexible communication architectures. NoC systems are typically formed of interconnects that are used to connect different modules on the chip, such as processors, memories, input/output modules and other components. Each interconnect in an NoC may comprise a router providing transport of data to and from a module in the network and a network interface (NI) that operates as an access point to the NoC for the module. Different interconnects forming the NoC may be connected via links. Accordingly, in the NoC, a message may be transferred from any source module to any destination module over one or more links, by making routing decisions at routers.

Performance of an integrated circuit where communications between modules are provided by an NoC may be determined at least in part by power that is consumed when data messages are transferred between interconnects of the network. The power consumed by an NoC may increase as the number of interconnects in the system increases. Thus, in a system employing an NoC for communication between a large number of modules power required to transfer multiple data messages between the modules may affect the overall performance and cost of the system. For example, an NoC system comprising multiple processors may consume significant amount of power. Furthermore, the power consumption by an NoC increases when messages such as multicast or broadcast are sent within the network.

### SUMMARY OF THE INVENTION

According to one embodiment of the invention, there is provided, in a network-on-chip system comprising at least one processor, a method of transferring a data message comprising a plurality of bytes, the method comprising with the at least one processor generating a data structure comprising a plurality of bits determining whether a byte from the plurality of bytes of the data message is set to a first value when it is determined that the byte is set to the first value, recording a bit in the data structure indicating that the byte is set to the first value so that each bit of the plurality of bits in the data structure indicates a value of a corresponding byte in the data message and generating a compressed message comprising the data structure and a portion of bytes from the plurality of bytes that are not set to the first value.

According to another embodiment, a number of the plurality of bits is equal to a number of the plurality of bytes.

According to another embodiment of the invention, the first value comprises zero.

According to another embodiment, the method further comprises, when it is determined that the byte is set to ‘0,’ recording the bit in the data structure comprises setting the bit to ‘1.’

According to another embodiment, the method further comprises, when it is determined that the byte is not set to zero, recording the bit in the data structure comprises setting the bit to ‘0.’

According to another embodiment, bits in the plurality are ordered in the same order as bytes in the plurality of bytes.

According to another embodiment, the method further comprises, converting the compressed message into a plurality of packets, wherein the packets in the plurality of packets have a format appropriate for transmission of the data message in the network-on-chip system.

According to another embodiment, the method further comprises uncompressing the compressed message to generate an uncompressed message, the uncompressing comprising processing a bit from the plurality of bits to determine whether the bit indicates that a corresponding byte in the data message is set to the first value when the bit indicates that the corresponding byte is set to the first value, recording a zero byte in the uncompressing message; and when the bit indicates that the corresponding byte is not set to the first value, reading a byte from the portion of bytes that are not set to the first value and recording the read byte in the uncompressing message.

According to another embodiment of the invention, there is provided a system for transferring at least one data message, the system comprising at least one first module comprising a processor configured to generate a data message comprising a plurality of bytes to be a sent to at least one second module in the system component configured to receive the data message from the processor record, in a data structure, for each byte from the plurality of bytes, an indicator indicating whether a value of the byte comprises a first value record at least one byte from the plurality of bytes that is not set to the first value and generate a compressed data message comprising the data structure and the at least one byte.

According to another embodiment, the method further comprises a unit configured to form a plurality of packets from the compressed data message.

According to another embodiment, the data structure comprises a plurality of bits, and wherein a bit from the plurality of bits corresponding to the byte comprises the indicator.

According to another embodiment, the method further comprises a second value when a value of a corresponding byte in the data message comprises the first value, and wherein the indicator comprises a third value when a value of the corresponding byte in the data message comprises a value different from the first value.

According to another embodiment, the method further comprises a second value “1” and the third value “0.”

According to another embodiment, the method further comprises a system network-on-chip system.

According to another embodiment, the component is further configured to process a bit from the plurality of bits to determine whether the bit indicates that a corresponding byte in the data message is set to the first value when the bit indicates that the corresponding byte is set to the first value, recording a zero byte in the uncompressing message and when the bit indicates that the corresponding byte is not set to the first value, reading a byte from the portion of bytes that are not set to the first value and recording the read byte in the uncompressing message.

### BRIEF DESCRIPTION OF DRAWINGS

The accompanying drawings are not intended to be drawn to scale. In the drawings, each identical or nearly identical component that is illustrated in various figures is represented by a like reference character. For purposes of clarity, not every component may be labeled in every drawing. In the drawings:

FIG. 1 is a high-level partial diagram of a network-on-chip architecture in which some embodiments of the invention may be implemented;

FIG. 2 is a high-level diagram of the network-on-chip architecture in which some embodiments of the invention may be implemented;

FIG. 3 is a schematic diagram of a computer system in which some embodiments of the invention may be implemented;

FIG. 4 is a schematic diagram of another computer system comprising a compressing/uncompressing unit, in accordance with some embodiments of the invention;

FIG. 5 is a flowchart illustrating a process of compressing a data message in an original format, in accordance with some embodiments of the invention;

FIG. 6 is a schematic diagram illustrating an original data message and a zero-byte vector indicating non-zero bytes of the original data message, in accordance with some embodiments of the invention; and

FIG. 7 is a schematic diagram illustrating an original data message and a compressed data message generated by compressing the original data message, in accordance with some embodiments of the invention.

### DETAILED DESCRIPTION

In a network-on-chip (NoC) system, multiple data messages may be transferred between modules of the system. Resources of the NoC system expended to transfer the data messages may consume a significant amount of power thus affecting the overall performance and efficiency of the system. The applicants have thus recognized and appreciated that performance of the NoC system may be improved in terms of cost, efficiency and power savings if the amount of power required to transfer the data messages between interconnects of the NoC is reduced.

In NoC systems, data messages are typically transferred across the network in their original format. A data message may comprise any suitable information transferred from one module to another. The data messages of the original format may comprise bytes one or more of which may be so-called “zero bytes” meaning that such bytes comprise only zero bits and therefore do not carry information. For example, a data message comprising a certain number of bytes (e.g., 64 bytes) may contain only one bit that is set to ‘1,’ with the rest of the bits set to ‘0.’

Accordingly, the applicants have appreciated and recognized that such redundancy in the data messages transmitted in the NoC system may be exploited to improve the performance of the system. Specifically, the applicants have appreciated and recognized that the redundancy may be reduced by employing data compression. Thus, some embodiments provide a compressing/uncompressing mechanism which may allow “compressing” a data message of an original format into a compressed message comprising only bytes of the data message that carry non-zero information along with information on positions of zero bytes in the data message. As such, the data message of a reduced size may be transmitted across the NoC. This may allow efficient use of hardware resources of the NoC system and result in reduction of power consumption required to transfer data messages within an NoC system, which may improve cost and the overall performance of the integrated circuit. Furthermore, advantages of NoC systems such as their versatility, scalability and reliability may thus be effectively utilized.

In some embodiments, the compressing/uncompressing mechanism may uncompress the compressed data message at a destination module to provide the data message of the original format.

In some embodiments, the compressing/uncompressing mechanism may allow reducing a size of a data message to be transferred across the NoC by transferring only non-zero bytes of the data message, which may be defined as bytes comprising any combination of bits set to ‘0’ and ‘1,’ along with information on zero bytes of the data message. The information on the zero bytes may be transferred as part of a set of indicators specifying for each byte of the data message whether this byte is a zero byte. Such information may be recorded in any suitable form. For example, the information may be recorded in a data structure of a suitable format generated by the compressing/uncompressing technique provided by some embodiments.

In some embodiments, the data structure may comprise the same number of entries as a number of bytes in the data message of the original format. Thus, each entry of the data structure may indicate whether a corresponding byte in the data message is a zero byte (i.e., the bytes that is set to ‘0’). It should be appreciated that the information on whether a byte of the data message is a zero byte may be recorded in any suitable manner as embodiments of the invention are not limited in this respect.

In some embodiments, bits in the data structure may be ordered in the same order as bytes in the data message to be compressed. For example, if the data message is recorded as a sequence of bytes so that its most significant byte is a left-most byte (i.e., if a big-endian format is used), the data structure may also include its most significant bit in the left-most position, which indicates a value of the left-most byte of the data message. Similarly, if the data message is recorded as a sequence of bytes so that its least significant byte is a left-most byte (i.e., if a little-endian format is used), the data structure may also include its least significant bit in the left-most position. Though, in some embodiments, bytes in the data message and bits in the data structure comprising information on the bytes may be recorded in different directions as long as the information on the order of bytes in the data message and bits in the data structure is recorded in the compressed message, which is then used in uncompressing the compressed message.

In some embodiments, the data structure may be referred to as a vector comprising the same number of bits as the number of bytes in the data message of the original format. In one embodiment, such vector may be referred to by way of example only as a “zero-byte vector” meaning that the vector indicates which of the bytes of the data messages are zero bytes. It should be appreciated that the vector may be of any suitable length and may comprise any additional information as embodiments of the invention are not limited in this respect.

After each byte of the data message in the original format has been examined and the data structure indicating which of the bytes of the data message are zero bytes is generated, the data structure may be associated with non-zero bytes of the data message to thus provide a compressed version of the data message in the original format. The data structure and the non-zero bytes may be associated is any suitable manner. For example, the data structure may be appended to the non-zero bytes.

Regardless of the way in which data structure and the non-zero bytes are associated, the resulting compressed data message may be converted into packets suitable to be transferred in the NoC. In some embodiments, prior to converting the compressed data message into packets, the compressed data message may be further split into blocks. Additional packet information may then be added to each block to transfer the block across the NoC in a packet format. In some embodiments, a packet may be split into so-called flits (“a flow of control digits”) which may be taken as packets of a smaller size. It should be appreciated that data messages may be transferred in the NoC in any suitable format as embodiment of the invention are not limited in this respect.

The compressed data message generated as described above may be smaller in size than the original data message. Any data message to be transferred in the NoC may be compressed in a similar manner. Accordingly, data messages of a smaller size may be transferred across the NoC which may result in reducing power dissipation caused by transferring messages in the network. This may improve overall performance of the NoC system.

Compressing a data message in accordance with some embodiments and thus reducing amount of data messages transferred in the NoC system may save power costs associated with transferring messages across the NoC. As an example, an original data message to be transferred from a source module in the NoC may comprise 64 bytes. Eight packets may be required to transfer the original data message in the NoC. If 24 out of the 64 bytes of the original data message are zero bytes, then non-zero bytes of the data message may encompass 40 bytes. A size of the data structure recording information on whether each byte of the data message in the original format is a zero byte may be, for example, eight bytes. Accordingly, a length of a compressed form of the original data message may be 40 non-zero bytes plus eight bytes of the data structure, thus being 48 bytes. This compressed message comprising 48 bytes may be then transmitted within the NoC from the source module to a destination module.

In the above example, after some additional information may be added to transmit the compressed data message in the NoC, six packets may be sufficient to transfer the compressed data message carrying all of the information included in the original data message, as compared to eight packets required to transfer the original data message prior to compressing the data message. As a result, a number of packets transmitted in the NoC may be reduced by 25 percent. It should be appreciated that any suitable reduction in a number of packets transmitted in the NoC may be achieved, depending on a number of zero bytes in the original data message.

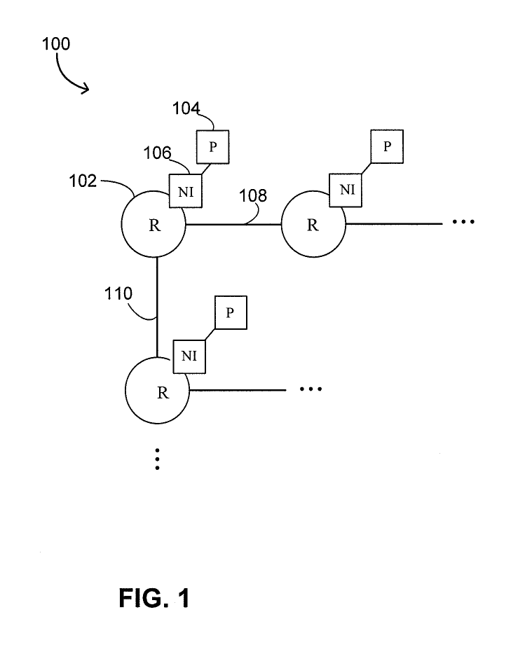

FIG. 1 illustrates schematically a fragment of a system 100 having an NoC infrastructure. A two-dimensional system system 100 is shown though embodiments of the invention are not limited in this respect. In this example, components of one interconnect of system 100 are labeled. However, it should be appreciated that system 100 may comprise any suitable number of interconnects comprising similar components. Each interconnect may be associated with a respective module, such as a processor or a memory, and may provide communications between this module and other modules in the NoC.

In the example illustrated, each interconnect of system 100 may comprise a routing node 102 (“R”), a processing node 104 (“P”) and a network interface 106 (“NI”) that operates as a bridge between routing node 102 and processing node 104. System 100 may provide communications between processing node 104 and other modules on the NoC. Although in this example the module that communicates with other modules via an NoC is by way of example only processing node 104, it should be appreciated an NoC may provide intercommunications for any other suitable modules such as memories, digital signal processors and others.

Routing node 102 may route data messages sent to and from processing node 104 as packets or in any other appropriate format, which may be performed in accordance with any suitable routing algorithm. Routing node 102 may include or be otherwise associated with one or more buffer storages that may temporarily store packets, flits or other suitable data. The storage(s) may comprise one or more memories of any suitable type.

Network interface 106 may be, for example, a network adapter that communicates data messages between nodes 102 and 104. The interconnects may be connected by links two of which, 108 and 110, are shown in FIG. 1 by way of example only. It should be appreciated that system 100 and each separate interconnect may comprise any other suitable components which are not shown herein for the simplicity of representation.

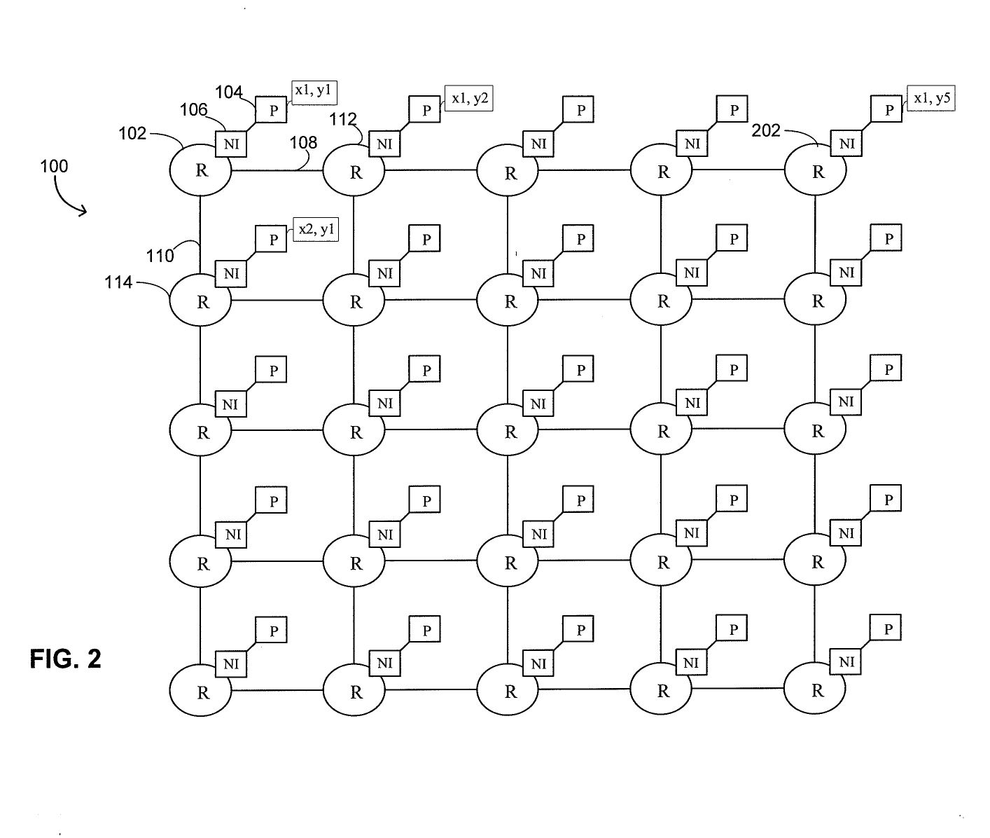

FIG. 2 illustrates schematically system 100 a fragment of which is shown in FIG. 1. System 100 may have NoC infrastructure formed on one or more chips. System 100 may comprise a plurality of modules, such as processing nodes, that may communicate via the NoC.

In this example, system 100 has a 5×5 two-dimensional (2D) mesh topology comprising 25 interconnects, each having coordinates (xₙ, yₘ), where n=1 . . . 5, and m=1 . . . 5. It should be appreciated that any other suitable topology of the NoC may be substituted as embodiments are not limited in this respect. Each of these interconnects may comprise by way of example only a processing node, a routing node and a network interface.

In the example illustrated, the interconnects may comprise components similar to those shown in FIG. 1. Accordingly, FIG. 2 illustrates an interconnect comprising the same components 102, 104 and 106 as shown in FIG. 1. Components of other interconnects of system 100 are not labeled for the simplicity of representation. Though, it should be appreciated that each interconnect in system 100 may comprise components similar to components 102, 104 and 106. Furthermore, it should be appreciated that the 2D mesh network with 25 interconnects is shown by way of example only and the NoC of any suitable topology comprising any number of suitable interconnects may be substituted.

In some embodiments, system 100 may have chip-multiprocessor (CMP) architecture. Though, it should be appreciated that any suitable type of a system formed on a single or multiple chips may be substituted.

In FIG. 2, routing node 102 is connected, via link 110, to a routing node 112. Routing node 102 is also connected, via link 108, to a routing node 112. In the 2D mesh of interconnects, coordinates of respective processors associated with routing nodes 102, 112, 114 and 202 are shown by way of example as (x₁, y₁), (x₁, y₂), (x₂, y₁), and (x₁, y₅), respectively. It should be appreciated that, though not shown for the simplicity of the representation, at each interconnect, a router, a network interface and a processor may be identified using the same coordinates reflecting a position of the interconnect in the network.

NoC systems may comprise a large number of modules, or interconnects, and a message sent from one module may reach its destination after being transferred through one or more intermediate modules. In order to maintain performance at a desired level and avoid deadlocks, a message may be split into two or more packets, and a packet may be further split into several flits to increase speed of data transfer.

Furthermore, in NoC systems, network bandwidth may be limited, and messages transferred across the network may be wider than the network bandwidth. Hence, to transfer a data message across the NoC, the data message may be divided into smaller fragments, which may be referred to as blocks, to fit the network bandwidth. For example, a data message of an original format of 64 byte length may need to be multicast to several destinations on a 2D-mesh network with a channel of 9-byte width (i.e., a width of the wires between adjacent interconnects is 9 bytes). In such scenarios, the original data message may be split (e.g., by a network interface or other suitable component) into eight blocks, with each block being 8 byte long. Further, additional information, such as a packet type, packet number, packet destination, whether the packet is a head packet and other information, may be added to each block to help transmitting the message in the NoC. Such information may be referred to as packet information. The packet information may comprise one byte or any other suitable number of bytes.

A block with the added packet information may be referred to herein as a packet. Accordingly, the 64-byte length data message may be split into eight packets, and the packets may then be sent one packet at a time or in any other suitable manner. It should be appreciated that while a 64-byte length message is described in this example, a data message of any suitable size may be substituted.

After a packet is generated as described above, it may be sent across the NoC. The data message in the original format may have one or more of its bytes set to ‘0.’ As a result, when the data message in the original format is split into packets, one or more of the packets may essentially carry no information. Thus, in some embodiments of the invention, transferring data messages of the original format may not be efficient.

In the example of FIG. 2, when the data message is to be transferred from the processor (x₁, y₁) to the processor (x₁, y₅), the processor (x₁, y₁) may first transfer the data message to NI(x₁, y₁). NI(x₁, y₁) may then transform the data message from its original format into packets suitable for transmission in the NoC, and the packets may then be sent out by the router (x₁, y₅). After a number of hops of transmission in the NoC, the packets may reach their destination router (x₁, y₅). After receiving the packets sent from the processor (x₁, y₁), the packets may be restored, on the router (x₁, y₅), to the data message of the original format, upon which this resulting data message may be transferred to the processor (x₁, y₅).

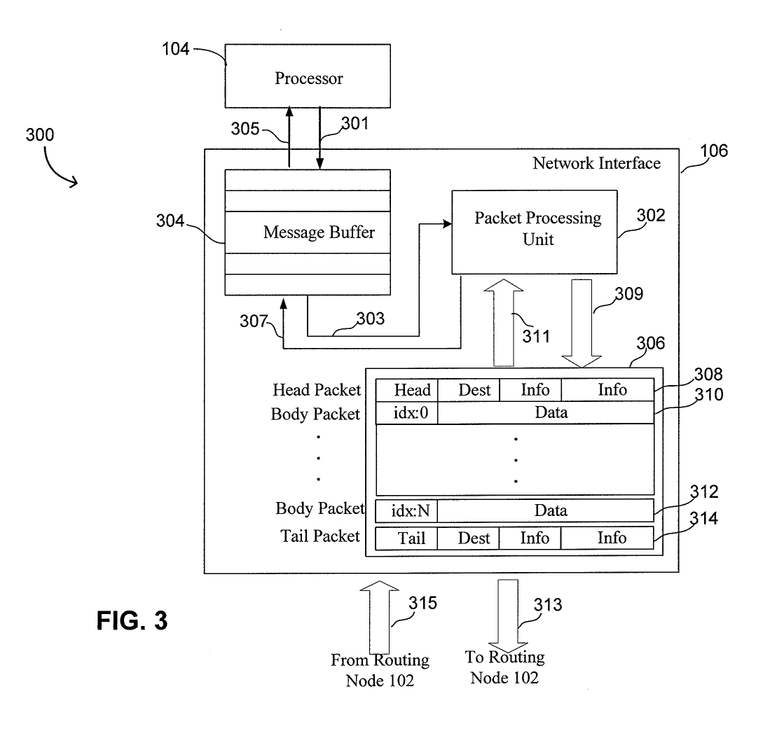

FIG. 3 conceptually illustrates a system 300, such as an interconnect in the NoC system, comprising a network interface 106 that couples a processing node, or a processor 104, to a routing node 102. In this example, network interface 106 comprises message buffer 304, which may be any suitable storage, and a packet processing unit 302. It should be appreciated that network interface 106 may comprise any other suitable components.

Message buffer 304 may store data in any suitable manner. For example, message buffer 304 may comprise one or more cache lines. A width of a cache line may be, for example, 64 bytes. Though, it should be appreciated that embodiments of the invention are not limited in this respect and cache lines of any suitable size may be utilized. Moreover, network interface 106 may be associated with any other suitable storage.

In some embodiments, a data message sent from a processor of one interconnect to a processor of another interconnect in the NoC may be, for example, a request for data generated by the other processor. The request may be a read request. Further, the data message may be a request for feedback after data has been sent to the other processor. When a data message is to be sent by processor 104, processor 104 may write the data message to message buffer 304, as shown by an arrow 301. Packet processing unit 302 coupled to message buffer 304 may read, as schematically shown by an arrow 303, the data message stored in message buffer 304 and transform the data message from its original format into a packet format, as shown by an arrow 309. Thus, packets suitable for transmission across the NoC may be generated.

Packet processing unit 302 may read a cache line storing the data message from message buffer 304. A width of the cache line may be, for example, 64 bytes. Accordingly, the 64-byte cache line may store a 64-byte length data message, which is the data message in the original format. However, in the NoC, the channel width may be smaller than the length of the cache line. Accordingly, to convert the data message in the original format into a form suitable for transmission across the NoC, packet processing unit 302 may split the data message into a suitable number of blocks. Each of blocks may then be supplemented with additional information required for transferring the blocks in the NoC. The additional information may comprise information on a type of the data message, a destination of the data message, and any other suitable information.

The generated packets are schematically shown as a component 306 in FIG. 3. The data message converted into a packet format may comprise one or more body packets that carry information of the data message, and a head and tail packets that include information used in transferring the body packets in the NoC. In this example, packets 306 is shown by way of example only to include a head packet 308, body packets 310-312 and a tail packet 314. It should be appreciated however that the packets may comprise any suitable number and types of fields.

In the example illustrated, each of packets 306 includes a field comprising an indicator indicating whether the packet is a head packet, body packet or a tail packet. Thus, head packet 308 comprises a packet header, “Head,” indicating that the packet is a head packet among packets 306. A body packet 310 may include a header, “idx:0,” indicating a sequence number of this packet. The sequence number may indicate a number (e.g., an order) of the packet among a sequence of packets 306 carrying information of the data message.

Packets from packets 306 may be transmitted across the NoC in any suitable order and the sequence number of each packet may be used to reassemble the packets into a data message at a destination module. In some embodiments, a hardware counter (not shown) may be used to generated the sequence numbers for the packets. Though, any suitable method may be used to generate the sequence numbers for the packets as embodiments of the invention are not limited in this respect.

In FIG. 3, body packet 310 is the first body packet among packets carrying information and therefore has a sequence number “0.” Any suitable number of body packets may be utilized to transfer the data message. In this example, a number of the body packets is N and the last body packet 312 therefore has a sequence number “N,” shown as “idx:N” in FIG. 3.

Head packet 308 may also comprise a field “Dest” identifying a destination address of a routing path of packets 306, and other fields, schematically shown as two fields “Info,” which may comprise any suitable information about the data message used when transferring packets 306 in the NoC. For example, the information may include a type of the data message, the total length of the data message, flow control information and any other suitable information. It should be appreciated that head packet 308 may comprise any suitable number of fields of any suitable size, as embodiments of the invention are not limited in this respect. Also, in some scenarios, one or more of the fields of head packet 308 may not be used.

Body packets 310 and 312, as well as any other body packets having sequence numbers between “0” and “N,” which are schematically shows as “. . . ” between body packets 310 and 312 in FIG. 3, may comprise a “Data” field carrying information of the data message.

As shown in FIG. 3, tail packet 314 comprises a header “Tail” indicating that this is the last packet of packets 306. Tail packet 314 further comprises a destination field “Dest” identifying a destination address of a routing path of packets 306 and suitable information fields “Info.” It should be appreciated that embodiments of the invention are not limited to any particular format of packets used to transfer data messages in the NoC.

In some embodiments, the generated packets may be further divided into smaller units, such as, for example, flits. The generated packets or other suitable units may be sent to routing node 102, as schematically shown by an arrow 313, where they can be temporarily stored (e.g., in a buffer) prior to being sent to another processor in the NoC.

In network interface 106, data may flow in both inward and outward directions. Thus, FIG. 3 includes arrows 301, 303, 309 and 313 illustrating an outward flow of the data comprising the data message, which is converted in packet processing unit 302 into packets 306. Similarly, arrows 315, 311, 307 and 305 illustrate an inward flow of the data. In the inward flow, packets such as packets 306 are received, in a suitable order, and processed by packet processing unit 302 to extract the data message.

Data messages transferred in an NoC may comprise zero bytes, which, while not carrying any information, consume power resources of the NoC. Accordingly, transferring the data messages in an efficient manner that allows transmitting only non-zero information may save valuable resources of the NoC thus reducing its cost and improving its efficiency and performance.

In some embodiments, a network interface of an interconnect may comprise a component that performs compressing and uncompressing of data messages that are sent and received, respectively, by the network interface. A data message of an original format may be compressed so that only non-zero bytes of the data message are transferred across the NoC. The non-zero bytes may be supplemented with information on whether each byte of the data message is a zero byte. Accordingly, when the so compressed data message is uncompressed at a destination module, this information may be consulted to determine whether to reconstruct each byte of the data message as a zero byte or whether, when the information indicates so, to use a byte from the non-zero bytes.

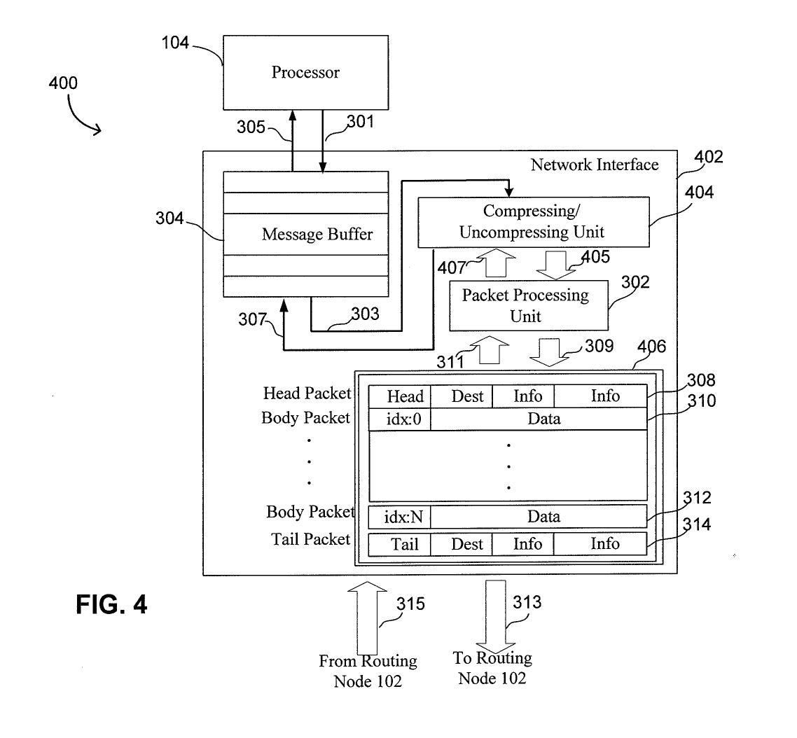

In some embodiments, the information on whether each byte of the data message is a zero byte may be recorded as respective bits of a suitable data structure. FIG. 4 illustrates a system 400 in accordance with some embodiments of the invention, such as an interconnect in the NoC system, which may comprise components similar to those included in system 300 (FIG. 3). However, in addition to the components shown in FIG. 3, system 400, comprising a network interface 402 that couples processor 104 to routing node 102, also comprises a compressing/uncompressing unit 404.

In the example illustrated, compressing/uncompressing unit 404 may couple message buffer 304 and packet processing unit 302. Compressing/uncompressing unit 404 may receive a data message in the original format from message buffer 304 and perform compressing of the data message into a compressed data message. The compressed data message may then be provided, as shown by an arrow 405, to packet processing unit 302, which may form packets 406 to be transmitted across the NoC. Packets 406 may be formed in any suitable manner and may comprise, for example, similar to packets 306 (FIG. 3), head packet 308, body packets 310-312 and tail packet 314. However, in comparison to packets 306, a smaller number of packets may be formed because of compressing the data message by compressing/uncompressing unit 404.

Compressing/uncompressing unit 404 may also perform uncompressing of compressed data messages received by network interface 402 from routing node 102. The uncompressing process may comprise processing that is reverse to compressing and restores the compressed messages to their original format. A data message compressed in accordance with some embodiments of the invention may be received by network interface 402 from routing node 102 as packets, such as packets 406, as shown by arrow 315 in FIG. 4. The received packets 406 may then be sent (311) to packet processing unit 302 which assembles packets 406 into the compressed data message. The thus reassembled compressed data message may be then uncompressed by compressing/uncompressing unit 404 to provide the data message of the original (i.e., uncompressed) format.

In some embodiments, compressing/uncompressing unit 404 may be implemented in hardware, software or any combination thereof as embodiments of the invention are not limited in this respect. Furthermore, compressing/uncompressing unit 404 may encompass more than one component.

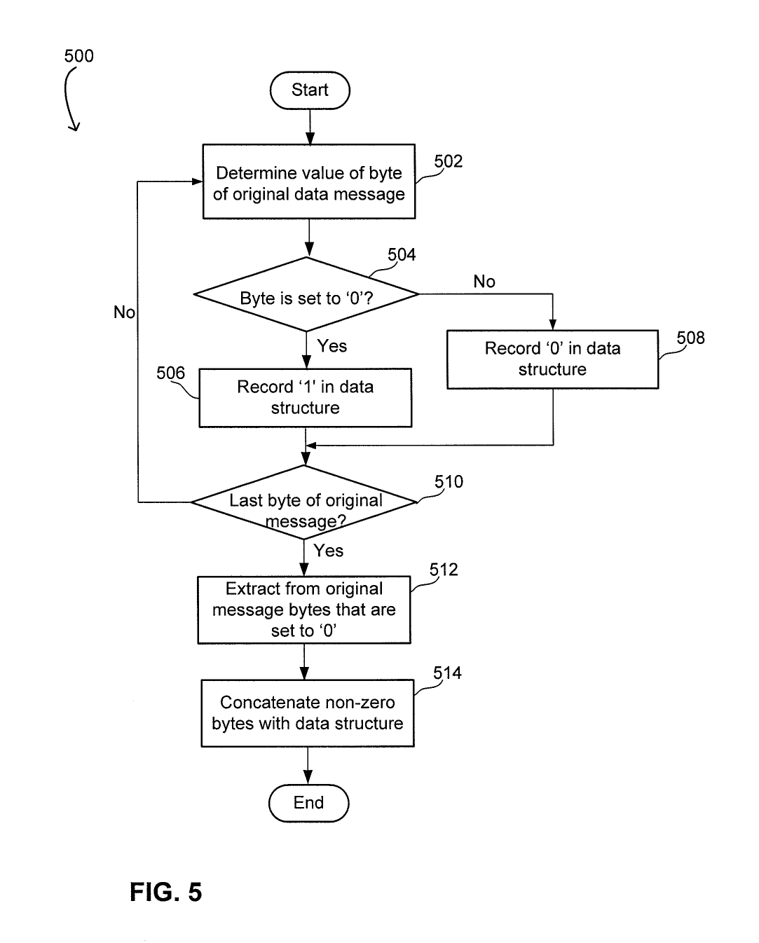

FIG. 5 illustrates a process 500 of compressing an original data message, which may be a data message of any suitable original format. Process 500 may start at any suitable time. For example, process 500 may start when a suitable component, such as compressing/uncompressing unit 404 (FIG. 4) receives the data message from a message buffer (e.g., message buffer 304) in the network interface (e.g., network interface 402) for compressing. For example, compressing/uncompressing unit 404 may read a cache line of message buffer 304.

At block 502, a value of a byte of the uncompressed data message may be determined. When process 502 begins, this value may be a value of the first byte of the uncompressed data message.

Next, at decision block 504, it may be determined whether the value of the byte determined at block 502 is set to “0.” In some embodiments, a suitable storage such as, for example, a data structure may be used to record information on whether each byte in the original data message is set to “0” and is therefore referred to as a zero byte. The data structure may be, for example, a vector or any other suitable data structure. In some embodiments, the data structure may be referred to as a zero-byte-vector. The data structure may comprise of a number of bits equal to a number of bytes in the original data message. For example, if the size of the original data message is 64 bytes, the size of the data structure may be 64 bits. In some embodiments, the size of the original data message may depend on a size of a cache line, which may be, for example, 64 bytes. Though, other implementations may be utilized since embodiments of the invention are not limited to a particular size of the cache line.

If it is determined, at decision block 504, that the value of the byte is set to “0,” process 500 may branch to block 506 where an indicator indicating that the value of the byte is set to “0” may be recorded in the data structure. In this example, a respective bit of the data structure may be set to “1.” Though, in should be appreciated that any other suitable indicators may be used to indicate that the value of the byte of the original data message is set to “0.”

Alternatively, if it is determined, at decision block 504, that the value of the byte is not set to “0” meaning that the byte is a non-zero byte, process 500 may branch to block 508 where an indicator indicating that the value of the byte is not set to “0” may be recorded in the data structure. In this example, a respective bit of the data structure may be set to “0.” Though, it should be appreciated that any other suitable indicators may be used to indicate that the value of the byte of the original data message is not set to “0.”

Regardless of whether the “1” or “0” is recorded in the data structure, process 500 may continue processing at decision block 510 where it may be determined whether the byte whose value was determined at block 502 is the last byte of the original data message. It should be noted that bytes of the original data message may be processed in any suitable order and respective values of bits may be recorded in positions of the data structure corresponding to positions of the bytes in the original data message. Accordingly, the last byte denotes the byte of the original data message that is farthest from the byte that is processed first as described in process 500.

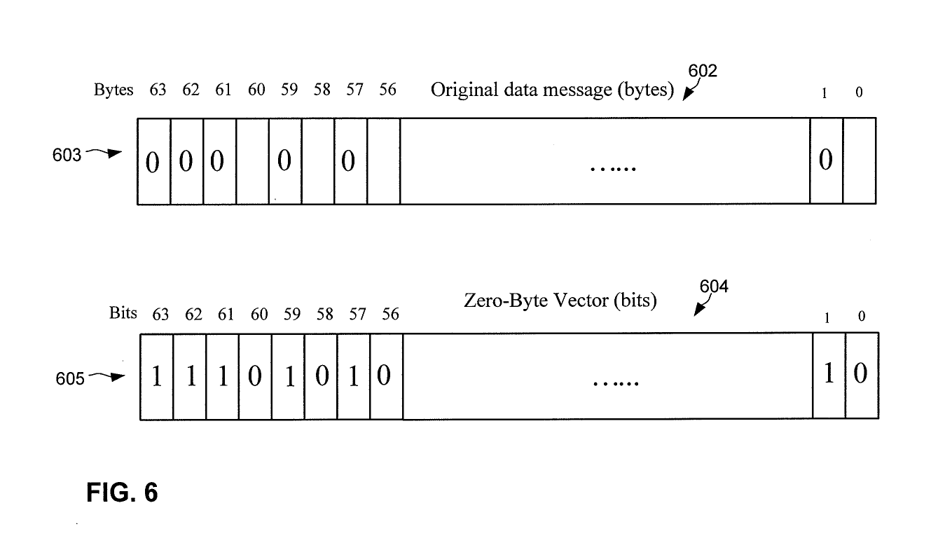

If the byte is not the last byte in the original data message—i.e., there are more bytes to be processed—process 500 may return to block 502 where a value of a next byte of the original data message may be determined. Processing at blocks 502-510 may thus be iterative, until all of the bytes of the original data message are processed. Examples of an original data message and a data structure, referred to by way of example only as a zero-byte vector, that includes, as a result of processing such as that shown in connection with FIG. 5, are shown in FIG. 6.

In FIG. 6, bits in a zero-byte vector are ordered in the same order as bytes in an original data message. An original data message 602 (i.e., a data message in the original format) comprises 64 bytes (indicated by numerical reference 603) labeled consecutively from 0 to 63. A zero-byte vector 604 comprises bits 605, also labeled consecutively from 0 to 63, where each bit from bits 605 comprises an indicator of whether the corresponding byte from bytes 603 is a zero byte or not. For example, byte 63 in original data message 602 is zero byte; therefore, respective bit 63 in zero-byte vector 604 is set to “1.” However, byte 60 in original data message 602 is non-zero byte and respective bit 60 in zero-byte vector 604 is therefore set to “0.”

If it is determined, at decision block 510, that the byte is the last byte in the original data message, which indicates that all of the bytes of the original data message have been processed, process 500 may continue to block 512 where bytes in the original message that are set to “0” may be extracted from the original data message. As a result, a new cache line may be generated that includes only non-zero bytes of the original data message. The bytes in the non-zero bytes are ordered in the same order as bytes in the original data message.

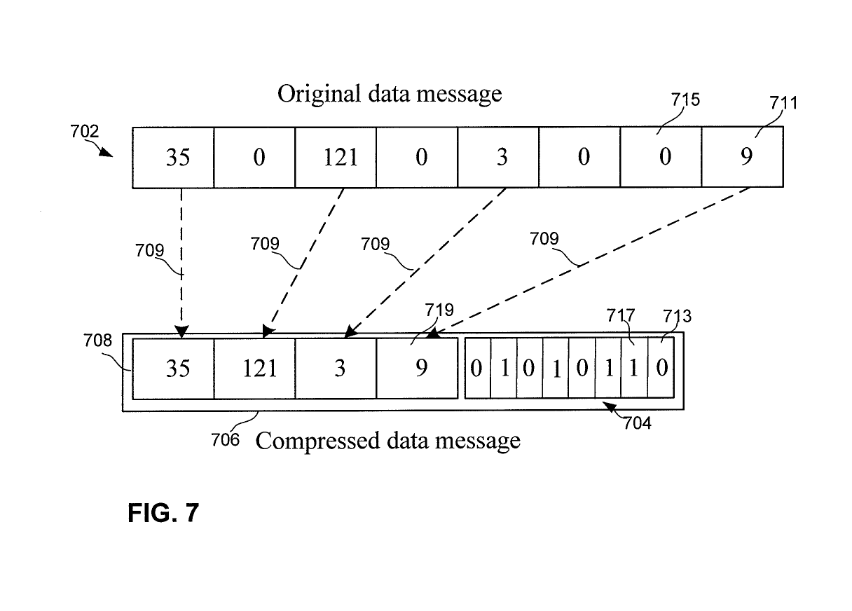

Process 500 may then continue to block 514, where the non-zero bytes of the original data message may be appended to or otherwise associated with the data structure, such as the zero-byte vector, to generate a compressed data message. An example of such a process is illustrated in connection with FIG. 7, where original data message 702, shown by way of example only as comprising eight bytes, is compressed into its compressed version, message 708, of only four non-zero bytes from original data message 702. Arrows 709 in FIG. 7 indicate which bytes of original data message 702 are recorded in message 708. It should be appreciated that, in some embodiments, data in original data message 702 is read from a cache line and is recorded into a new cache line comprising non-zero bytes 708. Though, other implementations of the original data message and its compressed version may be substituted as embodiments of the invention are not limited in this respect.

Information on whether each byte of original data message 702 is a zero byte or a non-zero byte is recorded in a data structure 704 (e.g., a zero-byte vector). A number of bits in data structure 704 may be equal to a number of bytes in original data message 702. In this example, data structure 704 comprises eight bits. Though, it should be appreciated that any suitable size of the data structure number may be utilized.

Similarly to FIG. 6, FIG. 7 illustrates by way of example only indicators recoded in data structure 704 which indicate whether each byte in original data message 702 is a zero byte or a non-zero byte. In this example, bits in the zero-byte vector are ordered in the same order as bytes in the original data message. Thus, because byte 711 in original data message 702 is a non-zero byte, a respective bit 713 in data structure 704 is set to “0.” However, byte 715 in original data message 702 is a zero byte and a respective bit 717 in data structure 704 is therefore set to “1.” Other bits in data structure 704 are similarly set, based on values of respective bytes in original data message 702, which is not shown for simplicity of representation.

In some embodiments, a compressed data message 706 may be generated (e.g., by compressing/uncompressing logic 404 in FIG. 4) by concatenating data structure 704 to non-zero bytes 708. The compressed data message 706 may be transferred to a component, such as a packet processing unit (e.g., packet processing unit 302 in FIG. 4) for further processing.

Accordingly, the packet processing unit may convert compressed data message 706 into smaller units, such as blocks, and add to the blocks information for transferring the blocks in the NoC to thus generate packets (e.g., packets 406 shown in FIG. 4). The packets may then be transferred, in any suitable order, across the NoC to a destination node. It should be appreciated that even though data messages are described herein as being transferred in the NoC in a packet format, the data messages may be transferred in the NoC in any other suitable manner as embodiments of the invention are not limited in this respect.

In the NoC, interconnects, or modules, both send and receive data messages, as illustrated in connection with FIG. 4. The packets carrying information of the original data message sent, along with a zero-byte vector, by a source module may be received at a destination module. When the destination module receives all of the packets together carrying in a compressed form t he information of the original data message, the packets may b e reassembled into the compressed data message.

The compressed message may be uncompressed by a suitable component, such as compressing/uncompressing unit 404 (FIG. 4), using information in the zero-byte vector. Because each bit of the zero-byte vector indicates whether a corresponding byte of the compressed message is a zero-byte or a non-zero byte, the original data message may be restored utilizing the information in the zero-byte vector. For example, referring back to FIG. 7, when the compressing/uncompressing unit receives compressed data message 706, the compressing/uncompressing unit may determine that compressed data message 706 comprises non-zero bytes 708 and data structure 704.

Depending on the order of the bits in data structure, the compressing/uncompressing unit may process first either the left-most or the right-most bit of the data structure. When the compressed data message is generated as compressed data message 706 in FIG. 7, the compressing/uncompressing unit may first process bit 713 of data structure 704 and determine that bit 713 is set to “0.” This indicates that a corresponding byte in the original data message 702 is non-zero and is therefore recorded as part of non-zero bytes. In this example, byte 711 from original data message 702 is shown as byte 719 in non-zero bytes portion 708 of compressed data message. Accordingly, byte 719 may be recorded as the first byte of the uncompressed message. Byte 719 comprises the same information as byte 711 but is labeled differently to indicate that non-zero bytes portion 708 may be recorded in different area in memory from an area where original data message 702 is recorded. Moreover, while the order of the bytes in the original data message is preserved in the non-zero bytes portion of the compressed data message, since zero bytes are not recorded in the non-zero bytes portion, the consecutive numbering of the non-zero bytes may be different.

Further, after byte 719 is recorded as the first byte of the uncompressed message, next bit 717 of data structure 704 may be processed. Bit 717 is set to “1” which indicates that the corresponding byte of the original data message 702 is a zero-byte (which is shown as byte 715 in FIG. 7). Accordingly, a zero byte may be recorded as the next byte of the uncompressed message. The rest of the bits of data structure 704 may be processed in the same manner. As a result, the uncompressed data message is generated that comprises information of the original data message.

Although the embodiments discussed above relate to compressing and uncompressing data messages to be transferred in NoC systems, the described techniques for compressing/uncompressing data messages may be implemented in any other suitable systems. Any suitable data message comprising information that may be transmitted in a shortened form may be compressed as described in accordance with some embodiments and then uncompressed to its original format. The compressed data messages may be transmitted over any suitable media and any type of a communication channel. Furthermore, information about whether each byte of a data message is set to “0” may be recorded in any suitable manner and stored in any suitable format.

The above-described embodiments of compressing/uncompressing unit 404 may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more compressing/uncompressing units that perform the above-discussed functions. In some embodiments, separate components may perform compressing and uncompressing functions, respectively. The one or more compressing/uncompressing units can be implemented in numerous ways, such as with dedicated hardware, or with general purpose hardware (e.g., one or more processors) that is programmed to perform the functions recited above.

Further, it should be appreciated that a computer may be embodied in any of a number of forms, such as a rack-mounted computer, a desktop computer, a laptop computer, a tablet computer, or in any other suitable computer. Additionally, a computer may be embedded in a device not generally regarded as a computer but with suitable processing capabilities, including a Personal Digital Assistant (PDA), a smart phone or any other suitable portable or fixed electronic device.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, some embodiments may be embodied as a computer readable storage device (or multiple computer readable media) (e.g., a computer memory, one or more floppy discs, compact discs (CD), optical discs, digital video disks (DVD), magnetic tapes, flash, memories, circuit configurations in Field Programmable Gate Arrays or other semiconductor devices, or other non-transitory, tangible computer storage medium) encoded with one or more programs that, when executed on one or more computers or other processors, perform methods that implement the various embodiments discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, embodiments of the invention may be implemented as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. In a network-on-chip system comprising at least one processor, a method of transferring a data message comprising a plurality of bytes, the method comprising:
with the at least one processor:
generating a data structure comprising a plurality of bits;
determining whether a byte from the plurality of bytes of the data message is set to a first value;
when it is determined that the byte is set to the first value, recording a bit in the data structure indicating that the byte is set to the first value so that each bit of the plurality of bits in the data structure indicates a value of a corresponding byte in the data message; and
generating a compressed message comprising the data structure and a portion of bytes from the plurality of bytes that are not set to the first value.

2. The method of claim 1, wherein a number of the plurality of bits is equal to a number of the plurality of bytes.

3. The method of claim 1, wherein the first value comprises zero.

4. The method of claim 3, further comprising, when it is determined that the byte is set to ‘0,’ recording the bit in the data structure comprises setting the bit to ‘1.’

5. The method of claim 3, further comprising, when it is determined that the byte is not set to zero, recording the bit in the data structure comprises setting the bit to 0.

6. The method of claim 1, wherein bits in the plurality of bits are ordered in the same order as bytes in the plurality of bytes.

7. The method of claim 1, further comprising converting the compressed message into a plurality of packets, wherein the packets in the plurality of packets have a format appropriate for transmission of the data message in the network-on-chip system.

8. The method of claim 1, further comprising uncompressing the compressed message to generate an uncompressed message, the uncompressing comprising:
processing a bit from the plurality of bits to determine whether the bit indicates that a corresponding byte in the data message is set to the first value;
when the bit indicates that the corresponding byte is set to the first value, recording a zero byte in the uncompressing message; and
when the bit indicates that the corresponding byte is not set to the first value, reading a byte from the portion of bytes that are not set to the first value and recording the read byte in the uncompressing message.

9. A system for transferring at least one data message, the system comprising:
at least one first module comprising:
a processor configured to generate a data message comprising a plurality of bytes to be a sent to at least one second module in the system;
a component configured to:
receive the data message from the processor;
record, in a data structure, for each byte from the plurality of bytes, an indicator indicating whether a value of the byte comprises a first value;
record at least one byte from the plurality of bytes that is not set to the first value; and
generate a compressed data message comprising the data structure and the at least one byte.

10. The system of claim 9, further comprising a unit configured to form a plurality of packets from the compressed data message.

11. The system of claim 9, wherein the data structure comprises a plurality of bits, and wherein a bit from the plurality of bits corresponding to the byte comprises the indicator.

12. The system of claim 10, wherein the indicator comprises a second value when a value of a corresponding byte in the data message comprises the first value, and wherein the indicator comprises a third value when a value of the corresponding byte in the data message comprises a value different from the first value.

13. The system of claim 12, wherein the second value comprises “1” and the third value comprises “0.”

14. The system of claim 12, wherein the system comprises a network-on-chip system.

15. The system of claim 9, wherein the component is further configured to:
process a bit from the plurality of bits to determine whether the bit indicates that a corresponding byte in the data message is set to the first value;
when the bit indicates that the corresponding byte is set to the first value, recording a zero byte in the uncompressing message; and
when the bit indicates that the corresponding byte is not set to the first value, reading a byte from the portion of bytes that are not set to the first value and recording the read byte in the uncompressing message.

16. In a network-on-chip system comprising at least one processor, a method of generating an uncompressed data message from a compressed data message comprising a first portion having a plurality of bytes and a second portion having a plurality of bits, the method comprising:
with the at least one processor:
for each bit from the plurality of bits:
determining whether the bit is set to a first value;
when it is determined that the bit is set to the first value, recording a corresponding byte from the plurality of bytes in the uncompressed message; and
when it is determined that the bit is not set to the first value, recording a zero byte in the uncompressed message.

17. The method of claim 16, wherein the first value comprises “0”.

18. The method of claim 16, wherein the compressed data message is received from a node in the network-on-chip system.

19. The method of claim 16, wherein a number of bytes in the first portion is equal to a number of bites in the second portion and wherein bytes in the plurality of bytes are ordered in the same order as bits in the plurality of bits.

20. The method of claim 16, wherein determining that the bit is not set to the first value comprises determining that the bit is set to “1.”
